(19) United States
(12) Patent Application Publication
(10) Pub. No.: US 2014/0175162 A1
(43) Pub. Date: Jun. 26, 2014

(54) Identifying Products As A Consumer Moves Within A Retail Store

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/723,085

(22) Filed: Dec. 20, 2012

(51) Int. Cl. G06Q 30/06

(52) U.S. Cl. CPC G06Q 30/0643
USPC 235/375

(57) ABSTRACT

A computer-implemented method is disclosed herein. The method includes the step of receiving, at a processing device of a commerce server, a video signal containing a barcode from an augmented reality device worn by a consumer shopping in a retail store. The method also includes the step of identifying, with the processing device, the barcode in the video signal. The method also includes the step of correlating, with the processing device, the barcode with a product offered for sale in the retail store.

### BACKGROUND INFORMATION

1. Field of the Disclosure

The present invention relates generally to processing a video signal that contains an image of a barcode. The barcode can be associated with a product that is in the field of view of a consumer.

2. Background

Manufacturers expend significant resources to better understand consumer purchasing habits in order to more effectively market products to consumers. The movement of consumers within a retail store can provide opportunities for marketing products to consumers. For example, if it were known that a consumer was moving toward a particular product, information and promotions associated with that product could be provided to the consumer. However, a retail store may extend across a large area and the retail store may offer thousands of different products for sale. It is not feasible to provide information to a consumer regarding all of the available products, nor is it feasible to request that the consumer advise the retail store of the consumer's expected path of movement.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustration of a commerce server that can be applied in some embodiments of the present disclosure.

FIG. 4 is an example of a view of a display visible with the augmented reality device as a consumer is shopping in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist in using barcodes to communicate information to the consumer, the information being associated with products that are proximate to the consumer. A barcode configured to be identified in a video signal can be applied to the front of a product in some embodiments of the present disclosure. The consumer can shop within the retail store wearing an augmented reality device configured to generate and transmit a video signal. As the consumer approaches various products, the video signal can be processed by a commerce server. The commerce server can identify one or more barcodes visible in the video signal. Each barcode can correspond to a product that the consumer is approaching or passing while shopping. The product may or may not be an object of the consumer's shopping interest.

The commerce server can identify the products that the consumer is approaching based on the barcodes that are identified. The commerce server can correlate the products that are identified through analysis of the video signal with information about those products. Product information can be stored in a database accessible by the commerce server. The commerce server can transmit the information about products to the augmented reality device worn by the consumer. The product information can be presented to the consumer in video format or audio format.

A system according to some embodiments of the disclosure can include a commerce server receiving video containing a barcode and generated as a consumer is viewing or passing products in a retail store. An augmented reality device, such as a head mountable unit for example, can transmit the video signal containing a barcode as the consumer shops.

In some embodiments of the present disclosure, the signal received by the commerce server can be a video signal in which barcodes of one or more are scanned by a camera having scanning technology capable of reading such barcodes. The products can be disposed on the shelf of retail store. The camera can be a component of an augmented reality device worn by the consumer. The video signal can be processed using known video recognition/analysis techniques and algorithms to identify a barcode that is captured by the camera.

Any barcode technology known to those skilled in the art may be utilized in systems according to this disclosure. One embodiment includes computer vision techniques that use methods for acquiring, processing, analyzing, and understanding images such as one-dimensional and two-dimensional barcodes. Easily detectible two-dimensional barcodes can also be applied in embodiments of the disclosure. Such barcodes are detectable by computer vision techniques and can be scanned by a scanner, even if the barcode is not directly in the field of view or centered in the field of view.

Computer vision technology can be used to capture barcodes. Examples of computer vision technology operable for use in some embodiments of the present disclosure CCD (charge coupled device) readers, video camera readers, and large field-of-view readers. A charge-coupled device (CCD) camera can use an array of hundreds of light sensors. Each sensor can measure the intensity of the light that is detected. Each individual light sensor in the CCD reader is extremely small and because there are hundreds of sensors, a voltage pattern identical to the pattern in a barcode can be generated by sequentially measuring the voltages across each light sensor.

Two-dimensional imaging scanners can be applied in some embodiments of the present disclosure. Two-dimensional imaging scanners use a video camera and image processing techniques to read and analyze barcodes. Video camera readers use similar technology as the CCD barcode reader except that instead of having a single row of light sensors, a video camera has hundreds of rows of light sensors arranged in a two dimensional array in order to generate a two-dimensional image.

Another barcode scanner or reader contemplated by this disclosure is large field-of-view (LFOV) readers. LFOV scanners use high resolution cameras to capture multiple barcodes simultaneously. Computer vision technology operates with LFOV such that all the barcodes appearing in the video can be decoded instantly.

In some embodiments, a barcode can be positioned on the front of product so that a video camera, in an augmented reality device worn by a consumer, can easily capture the barcode. However, the present disclosure is not limited to such embodiments; a barcode can be placed anywhere on a product. If the barcode is not on the front of the product, a consumer can be prompted to move the product into a position in which the barcode can be captured by the camera. In such embodiments, a product recognition signal can be transmitted to the consumer when the barcode has been successfully captured.

Capturing a barcode with a camera can take place when the consumer grasps and inspects a product. Barcodes can also be captured when a video signal is continuously transmitted to a processing device of the commerce server. The video signal can be continuously transmitted while the consumer is shopping in a retail store. In some embodiments, a video signal can be parsed to reduce the transmission of data. For example, image files can be transmitted at a predetermined rate to the commerce server instead of a live video feed. Further, the video can be modified from color to black and white to further reduce transmission load and/or ease the burden of processing. Also, the video can cropped to an area of interest to reduce the transmission of data to the commerce server.

In some embodiments of the present disclosure, the head mountable unit can transmit more than one signal that is received by the commerce server. The video signal transmitted by the head mountable unit can be processed to identify a barcode, but other signals can also be processed to complement the video signal. The position of the head mountable unit within the retail store can be detected as the barcode is captured. The position of the head mountable unit can be compared with a preliminary identification of the barcode.

For example, when a barcode is captured the commerce server can also receive a position signal from the head mountable unit. The position signal can be correlated with data in a product database that contains the identities and locations of products offered for sale in the retail store. A subset of all products in the retail store can be determined in response to the position signal; this subset of products would include products that are proximate to the head mountable unit based on the position signal.

The preliminary identification of the barcode can be compared to the subset of products that are proximate to the consumer. If the preliminary identification of the barcode is not associated with a product that is part of the subset of products that are proximate to the consumer, the identification of the barcode can be reassessed by the commerce server.

In some embodiments of the present disclosure, the barcode identity that is initially derived can also be assessed in view of a direction signal that is transmitted by the head mountable unit. The direction of the consumer can be contained in the direction signal emitted by the head mountable unit and received by the commerce server. The data in the direction signal can be correlated to data in the product database to narrow the set of possible products that are associated with the barcode captured in the video signal. If the preliminary identification of the barcode is not associated with a product that is part of the subset of products that is in the direction that the consumer is facing, the identification of the barcode can be reassessed by the commerce server.

In some embodiments of the present disclosure, the identity of the barcode can also be assessed in view of an orientation signal transmitted by the head mountable unit. The orientation of the consumer's head can be contained in the orientation signal emitted by the head mountable unit and received by the commerce server. For example, the orientation signal can indicate that the consumer is viewing a bottom shelf, a middle shelf, or a top shelf. If the preliminary identification of the barcode is not consistent with the orientation of the consumer's head, the identification of the barcode can be reassessed by the commerce server.

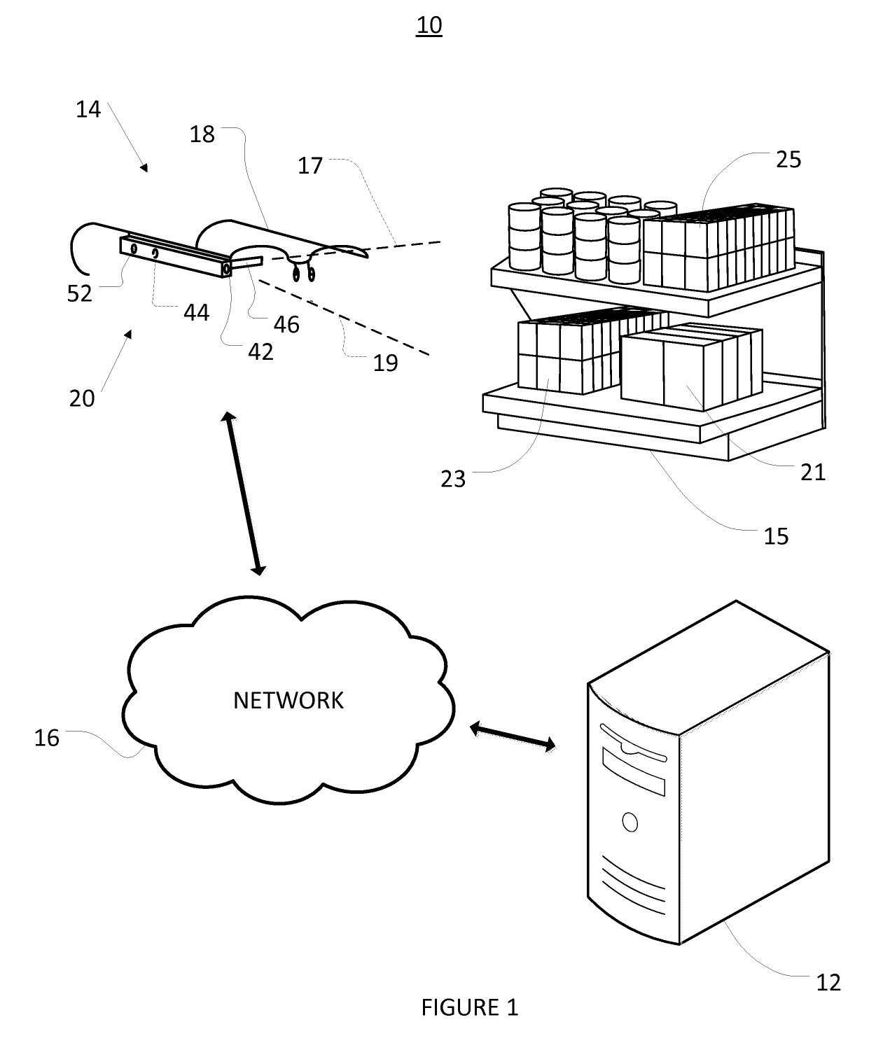

To illustrate, FIG. 1 is a schematic illustrating a monitoring system 10 according to some embodiments of the present disclosure. The monitoring system 10 can be a computer-implemented method that includes the step of scanning barcodes of a product with a commerce server 12 as a consumer is shopping within a retail store. The information can be received as a data signal from a video scanner associated with an augmented reality device such as a head mountable unit 14. The head mountable unit 14 can be worn by a consumer while shopping within a retail store. In the illustrated embodiment of FIG. 1, the exemplary head mountable unit 14 includes a frame 18 and a communications unit 20 supported on the frame 18. One or more cameras 42 can be operably attached to the head mounted unit 14.

A video signal can be transmitted from the head mountable unit 14 in which a portion of store shelving 15 is in the field of view of the camera 42. It is noted that embodiments of the present disclosure can be practiced in retail stores not using shelving and in retail stores partially using shelving. The direction of the camera 42 is illustrated schematically by dashed lines 17 and 19. Dashed lines 17 and 19 represent edges of the field of view of the camera 42. One or more products, such as products 21, 23, and 25, can be disposed on the shelving 15 within the field of view of the camera 42.

The signals transmitted by the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

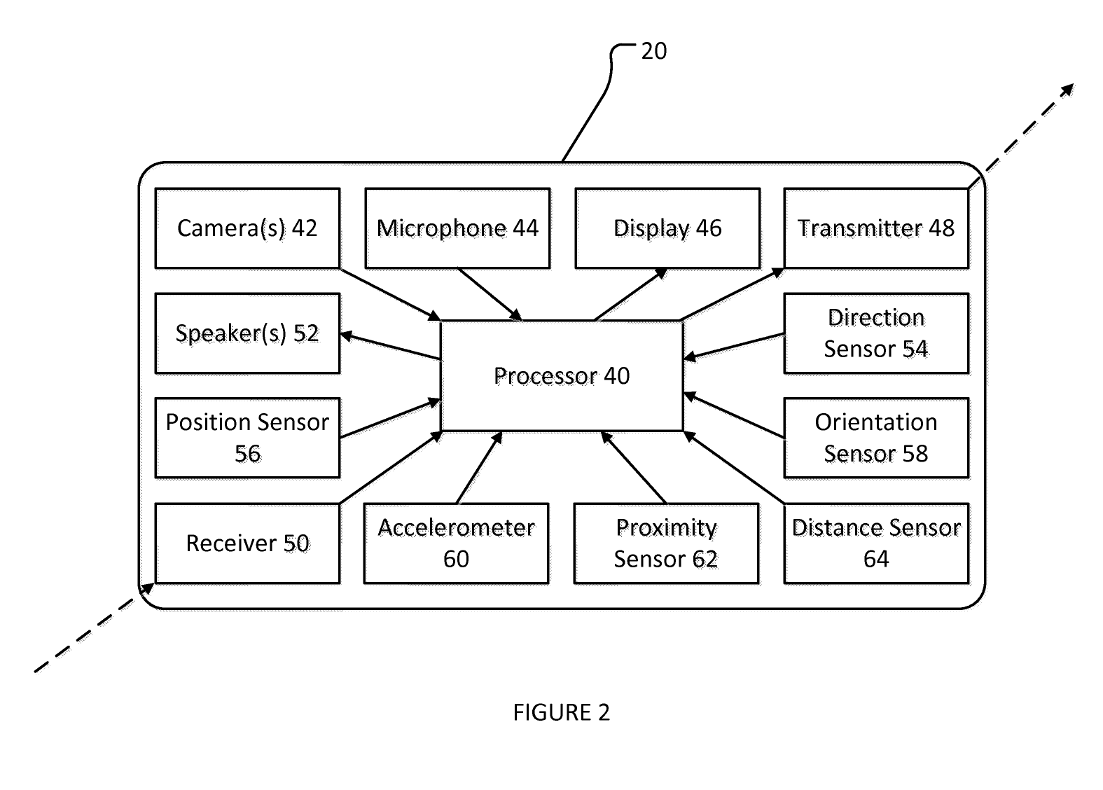

FIG. 2 is a block diagram illustrating exemplary components of the communications unit 20. The communications unit can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the consumer wearing the head mountable unit 14. Each camera 42 can be operable to capture single images and/or video and to generate a video signal based thereon. The video signal may be representative of the field of view of the consumer wearing the head mountable unit 14.

In some embodiments of the disclosure, the head mountable unit 14 can include a plurality of forward-facing cameras 42. The cameras 42 can define a stereo camera with two or more lenses, each with a separate image sensor. This arrangement allows the cameras 42 to simulate human binocular vision and thus capture three-dimensional images. This process is known as stereo photography. The cameras 42 can also be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the consumer is spaced from the object. Determining the distance that the consumer is spaced from the object can be executed by the processor 40 or by the commerce server 12 using known distance calculation techniques.

Processing of the one or more, forward-facing video signals can also be applied to determine the identity of a barcode. Determining the identity of a barcode can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can cropped to an area of interest to reduce the transmission of data to the commerce server 12.

In some embodiments of the present disclosure, the cameras 42 can include one or more inwardly-facing camera 42 directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the barcode that the consumer is viewing.

The microphone 44 can be configured to generate an audio signal that corresponds to sound generated by and/or proximate to the consumer. The audio signal can be processed by the processor 40 or by the commerce server 12. For example, verbal signals can be processed by the commerce server 12 such as “this product appears interesting.” Such audio signals can be correlated to the video recording.

The display 46 can be positioned within the consumer's field of view. Video content can be shown to the consumer with the display 46. The display 46 can be configured to display text, graphics, images, illustrations and any other video signals to the consumer. The display 46 can be a transparent when not in use and partially transparent when in use to minimize the obstruction of the consumer's field of view through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 48 and the transmitter 48 is operable to transmit the video signal and/or audio signal from the head mountable unit 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the consumer. The speaker 52 can be positioned within the consumer's range of hearing. Audio content transmitted by the commerce server 12 can be played for the consumer through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the consumer is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 16. By way of example and not limitation, the direction signal can be useful in determining the identity of a barcode(s) visible in the video signal, as well as the location of the consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the consumer within the retail store. The position sensor 56 can be configured to detect an absolute or relative position of the consumer wearing the head mountable unit 14. The position sensor 56 can electrically communicate a position signal containing position data to the processor 40 and the processor 40 can control the transmitter 48 to transmit the position signal to the commerce server 12 through the network 16.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the consumer and are visible in the video signal.

The orientation sensor 58 can be configured to generate an orientation signal indicative of the orientation of the consumer's head, such as the extent to which the consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the consumer's head can indicate whether the consumer is viewing a lower shelf, an upper shelf, or a middle shelf.

The accelerometer 60 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 60 can be a sensor that is operable to detect the motion of the consumer wearing the head mountable unit 14. The accelerometer 60 can generate a signal based on the movement that is detected and communicate the signal to the processor 40. The motion that is detected can be the acceleration of the consumer and the processor 40 can derive the velocity of the consumer from the acceleration. Alternatively, the commerce server 12 can process the acceleration signal to derive the velocity and acceleration of the consumer in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a consumer has grasped and is inspecting a product.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the consumer is facing. The distance signal can be useful in determining the distance to an object in the video signal generated by one of the cameras 42, which can be useful in determining the consumer's location in the retail store. The distance sensor 64 can operate as a laser based system as known to those skilled in the art. In one exemplary embodiment of the present disclosure the laser based distance sensor 64 can double as a barcode scanner. In this form, the distance sensor 64 can be used with an augmented reality device either solely or in combination with a video scanner to read barcodes associated with products in a retail store.

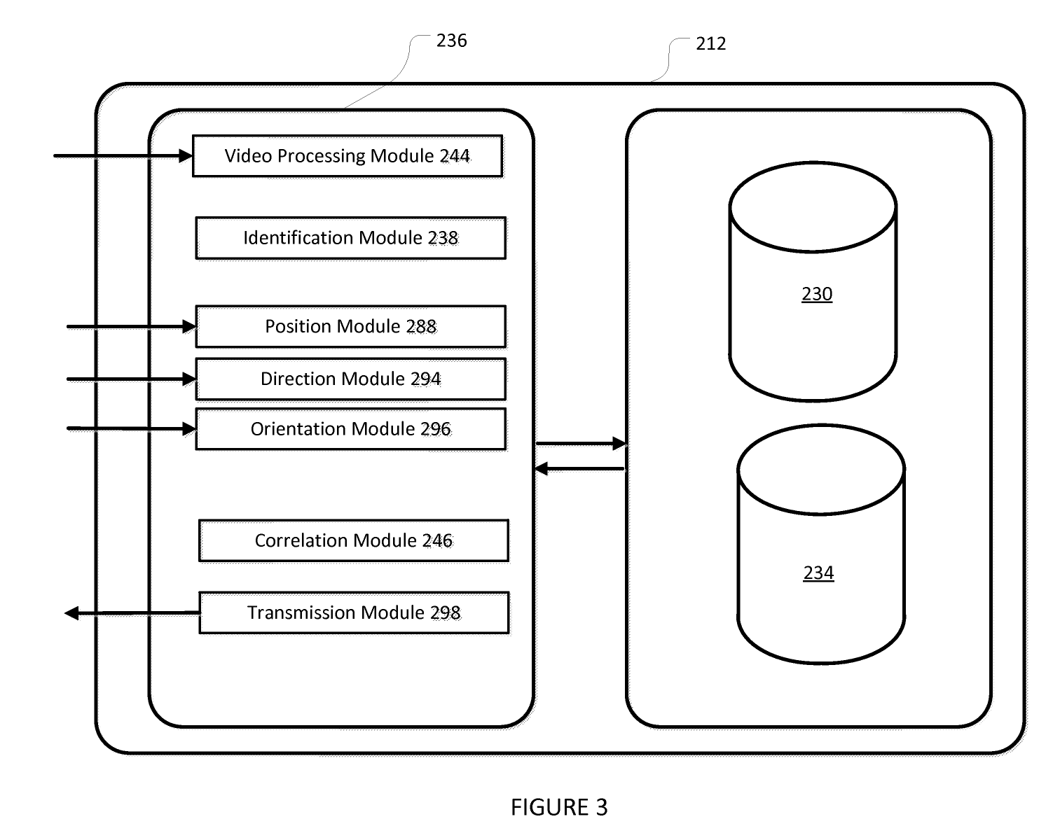

FIG. 3 is a block diagram illustrating a commerce server 212 according to some embodiments of the present disclosure. In the illustrated embodiment, the commerce server 212 can include a product database 230 and a consumer purchase history database 234. The commerce server 212 can also include a processing device 236 configured to include an identification module 238, a video processing module 244, a correlation module 246, a position module 288, a direction module 294, an orientation module 296, and a transmission module 298.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 230 can include in memory the identities of a plurality of products. The plurality of products can be the products offered for sale in a retail store associated with the commerce server 212 and the barcode associated with each of the products. The product database 230 can also contain a floor plan of the retail store, including the location of each of the plurality of products within the retail store. The product database 230 can also include information for each of the products that might be relevant to a consumer making a purchasing decision. For example, relevant information can be product promotions such as coupons, price reductions, or nutritional/performance data. The data in the product database 230 can be organized based on one or more tables that may utilize one or more algorithms and/or indexes.

The consumer purchase history database 234 can include in memory purchase histories of consumers, such as a purchase history of the consumer wearing the head mountable unit 14. The data in the consumer purchase history database 234 can be organized based on one or more tables that may utilize one or more algorithms and/or indexes.

The processing device 236 can communicate with the databases 230, 234 and receive one or more signals from the head mountable unit 14. The processing device 236 can include computer readable memory storing computer readable instructions and one or more processors executing the computer readable instructions.

The video processing module 244 can be operable to receive a video signal from the cameras 42 of the head mountable unit 14 and detect the presence of a barcode in the video signal. The video processing module 244 can analyze the video signal received from the head mountable unit 14. The video processing module 244 can implement known scanner recognition/analysis techniques and algorithms to detect a barcode.

The video processing module 244 can also be operable to function cooperatively with the identification module 238. For example, if the video processing module 244 detects a barcode, the video processing module 244 can direct the video signal and analysis of the video signal to the identification module 238. The identification module 238 can receive the analysis of the video signal and the analysis of the video signal by the video processing module 244 and determine the identity of the barcode. The identity of the barcode can be the data represented by the appearance of the barcode, including numbers, letters, and symbols.

The processing device 236 can also include a correlation module 246. The correlation module 246 can be operable to correlate the identified barcode with a product offered for sale in the retail store. The correlation module 246 can also extract information about the product from the product database 230. After a barcode is identified by the identification module 238 and correlated to a product offered for sale in the retail store by the correlation module 246, information about the product can be transmitted to the consumer with the transmission module 298 in some embodiments of the present disclosure. The information can be a product promotion, such as the notice of a sale on that product or a coupon. The information can also be data about the product, such as nutritional information if the product is edible or performance information for non-edible products.

In some embodiments, the processing device 236 can also include a position module 288. The position module 288 can be operable to function cooperatively with the correlation module 246 to confirm that the barcode has been accurately identified. The position module 288 can receive the position signal from the head mountable unit 14. The position signal can be generated by the indoor position sensor 56 and contain data corresponding to a location of the head mountable unit 14 within the retail store.

The position of the consumer within the retail store can correspond to a set of possible products that can be associated with the barcode that has been identified. The barcode that has been captured in the video signal will be associated with a product that is proximate to the consumer. The correlation module 246 can correlate a preliminary identification of the barcode to a product. A comparison of that product to products that are proximate to the consumer can confirm that the identification of the barcode is accurate. If the identification of the barcode does not correspond to a product that is proximate to the consumer, the identification module can repeat the step of identifying the barcode. If the identification of the barcode does correspond to a product that is proximate to the consumer, the accuracy of the correlation of the barcode to the product can be confirmed.

The accuracy of the identification of the barcode can be further assessed by other data generated by the augmented reality device. In some embodiments, the processing device 236 can also include a direction module 294. The direction module 294 can receive the direction signal from the head mountable unit 14. The direction signal can be generated by the direction sensor 54 and contain data corresponding to a direction of the head mountable unit 14 in the retail store. The direction of the consumer can be applied to assess the accuracy of the identification of the barcode. If the identification of the barcode does not correspond to a product that is in the forward direction of the consumer, the identification module can repeat the step of identifying the barcode. If the identification of the barcode does correspond to a product that is in the forward direction of the consumer, the accuracy of the correlation of the barcode to the product can be confirmed.

In some embodiments, the processing device 236 can also include an orientation module 296. The orientation module 296 can be operable to function cooperatively with the correlation module 246 to confirm the accuracy of the identification of the barcode. The orientation module 296 can receive the orientation signal from the head mountable unit 14. The orientation signal can be generated by the orientation sensor 58 and contain data corresponding to an orientation of the head mountable unit 14 in the retail store. For example, the orientation of the head mountable unit can be tilted downwardly when the consumer is looking at a lower shelf, tilted upwardly when the consumer is looking at an upper shelf, or generally level when the consumer is looking at a middle shelf. The orientation of the consumer can be a factor applied to assess the accuracy of the identification of the barcode. If the identification of the barcode does not correspond to a product that is in the direction of the consumer's head, the identification module can repeat the step of identifying the barcode. If the identification of the barcode does correspond to a product that is in the direction of the consumer's head, the accuracy of the correlation of the barcode to the product can be confirmed.

The correlation module 246 can also be operable to correlate the barcode received from the head mountable unit 14 with the purchase history of the consumer. The consumer can be identified based on the head mountable unit 14 being used in the retail store. For example, the head mountable unit 14 can be assigned a unique identifier such as a serial number. The unique identifier of the head mountable unit 14 can thus be associated with a particular consumer. The unique identifier can be communicated to the processing device 236. The correlation module 246 can search the purchase history database 234 based on the unique identifier and access the consumer's purchase history for the product associated with the barcode.

The consumer's purchase history can be applied in some embodiments of the present disclosure to select information to send to the consumer when a barcode has been identified and correlated to a product. For example, if an identified product has been previously purchased by the consumer and is presently on sale at a reduced price, the commerce server 212 can transmit this information to the consumer.

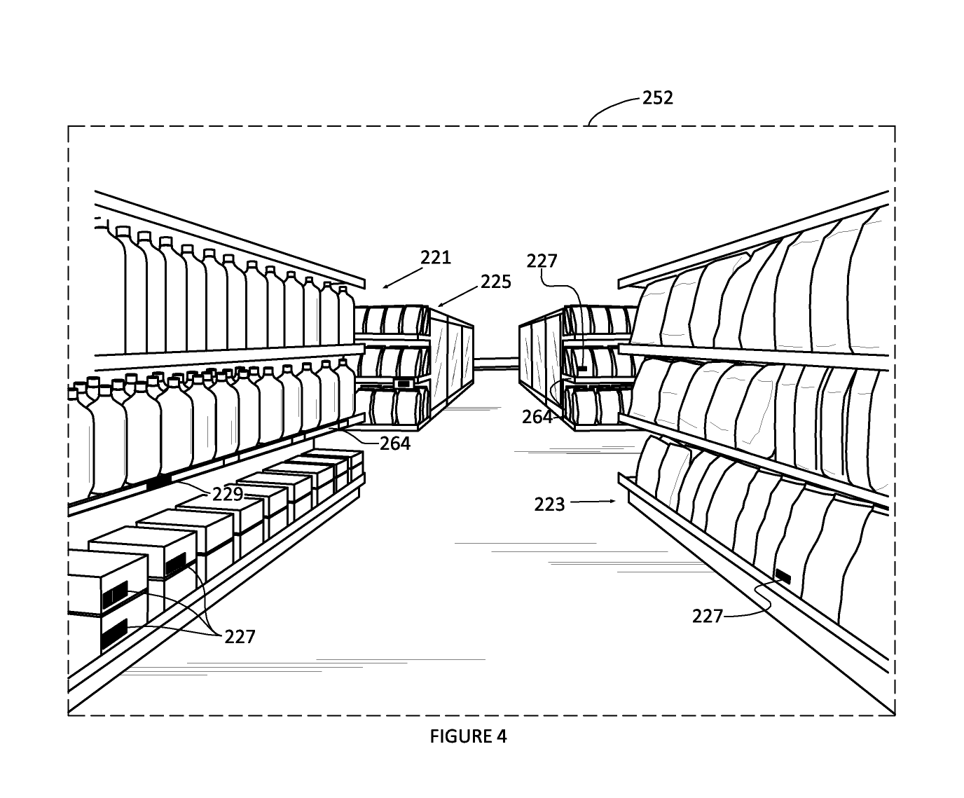

FIG. 4 illustrates a view that can be perceived by the consumer and by the video processing module 244 in some embodiments of the present disclosure. The illustrated field of view is taken in a retail store and can be visible to the consumer. The illustrated field of view can also be received as a video signal by the video processing module 244. The forward-facing cameras 42 and display 46 of the head mountable unit 14 can be generally aligned such that the display 46 overlaps the field of view of the cameras 42. In other words, the camera 42 is arranged so that the video signal received by the commerce server 212 is substantially similar to the field of view through the display 46.

The field of view can fill the display 252 or can be limited to a portion of the display 252. The consumer can look through at least part of the display 252 and view products, such as products 221, 223, 225, supported on shelves 264. The center of the display 252 can correspond to the focus of the consumer.

As the consumer moves through the aisle a plurality of barcodes 227 can be contained in the video signal generated by the camera 42. The barcodes 227 can be two-dimensional barcodes that are easily captured by the camera 42 despite being at varying distances and angles with respect to the camera 42. Other types of barcodes, such as a one-dimensional barcode 229, can also be utilized in embodiments of the present disclosure.

It is noted that the various processing functions set forth above can be executed differently than described above in order to enhance the efficiency of an embodiment of the present disclosure in a particular operating environment. The processor 40 can assume a greater role in processing some of the signals in some embodiments of the present disclosure. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the consumer.

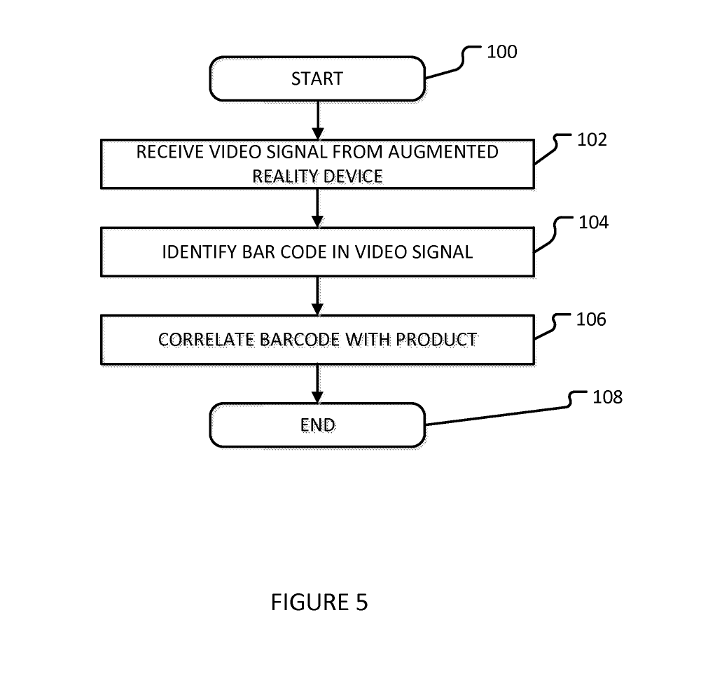

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 illustrates a method can be executed by a commerce server. The commerce server can be located at the retail store or can be remote from the retail store. The method starts at step 100. At step 102, the commerce server can receive video images containing a barcode from a camera associated with an augmented reality device. The field of view in the video signal can be indicative of a product being considered for purchase by a consumer or a product that the consumer is nearing.

At step 104, the barcode in the video signal is identified by the processing device. In some embodiments, the barcode can be shifted from the center of the consumer's field of view as the consumer might be moving as the image of the barcode is taken. At step 106, the identified barcode can be correlated with a product offered for sale in the retail store. In some embodiments of the present disclosure, after the barcode and then product are identified, the commerce server could identify the aisle of the product and thereby identify adjacent or nearby products as well. In some embodiments, when two barcodes are in the field of view and identifiable, a triangulation can be applied to determine many product locations if products haven't been moved or are being held. This could be accomplished by comparing two images at taken at some predetermined time period apart wherein the relative locations are stable. The exemplary method ends at step 108.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A method comprising:
receiving, at a processing device of a commerce server, a video signal containing a barcode from an augmented reality device worn by a consumer shopping in a retail store;
identifying, with the processing device, the barcode in the video signal; and
correlating, with the processing device, the barcode with a product offered for sale in the retail store.

2. The method of claim 1 further comprising:
transmitting, with the processing device, a signal containing information about the product to the augmented reality device.

3. The method of claim 1 wherein said receiving step further comprises:
receiving, at a processing device of a commerce server, a video signal containing a barcode not positioned in a center of a field of view of the video signal.

4. The method of claim 1 wherein said identifying step further comprises:
identifying, with the processing device, a two-dimensional barcode positioned on a front of the product.

5. The method of claim 1 wherein said identifying step further comprises:
identifying, with the processing device, a one-dimensional barcode positioned on the product.

6. The method of claim 1 wherein said identifying step further comprises:
identifying, with the processing device, a plurality of barcodes in the video signal.

7. The method of claim 1 further comprising:
prompting, with the processing device, the consumer to move the product such that a position of the barcode is moved closer to a center of a field of view of the video signal.

8. The method of claim 7 further comprising:
transmitting, with the processing device, a product recognition signal to the consumer in response to said prompting step.

9. The method of claim 8 wherein said transmitting step further comprises:
transmitting, with the processing device, a product recognition signal having at least one of video or audio data.

10. A commerce server comprising:
a processing device configured to receive a video signal from an augmented reality device worn by a consumer as the consumer moves within a retail store and including:
a video processing module configured to receive the video signal detect a presence of a barcode in the video signal;
an identification module configured to identify the barcode detected in the video signal; and
a correlation module configured to correlate the barcode identified by the identification module with a product offered for sale in the retail store.

11. The commerce server of claim 10 further comprising:
a transmission module configured to transmit a signal containing information about the product to the augmented reality device in response to the correlation of the barcode to the product by the correlation module.

12. The commerce server of claim 10 further comprising:
a position module configured to receive a position signal containing data corresponding to a location of the augmented reality device within the retail store and to function cooperatively with the correlation module and the identification module to confirm that the barcode has been accurately identified based on the position signal.

13. The commerce server of claim 10 further comprising:
a direction module configured to receive a direction signal containing data corresponding to a direction that the consumer is facing in the retail store and to function cooperatively with the correlation module and the identification module to confirm that the barcode has been accurately identified based on the direction signal.

14. The commerce server of claim 10 further comprising:
an orientation module configured to receive an orientation signal containing data corresponding to an orientation of the consumer's head and to function cooperatively with the correlation module and the identification module to confirm that the barcode has been accurately identified based on the orientation signal.

15. The commerce server of claim 10 further comprising:
a product database containing the identities of products offered for sale in the retail store, the locations of products within the retail store, and the barcode associated with each product.

16. The commerce server of claim 10 further comprising:
a purchase history database containing a purchase history of the consumer.

17. A method comprising:
receiving, at a processing device of a commerce server, a video signal containing a barcode from an augmented reality device worn by a consumer shopping in a retail store, wherein the barcode is spaced from a center of a field of view of the video signal;
identifying, with the processing device, the barcode in the video signal;
correlating, with the processing device, the barcode with a product offered for sale in the retail store; and
transmitting, with the processing device, a signal containing information about the product to the augmented reality device.

18. The method of claim 17 further comprising:
assessing the accuracy of said identifying step with another signal received from the augmented reality device.

19. The method of claim 17 wherein said identifying step further comprises:
identifying, with the processing device, a two-dimensional barcode positioned on a front of the product.

20. The method of claim 17 wherein said identifying step further comprises:
identifying, with the processing device, a one-dimensional barcode positioned on the product.
